(19) United States
(12) Patent Application Publication
(10) Pub. No.: US 2006/0069680 A1
(43) Pub. Date: Mar. 30, 2006

(54) System and method for creating fixed-format document

(76) Inventors: Yukio Kobayashi, Kanagawa (JP); Takeshi Kikuchi, Shizuoka (JP); Yoshihisa Kamagata, Kanagawa (JP); Seiji Ishii, Kanagawa (JP); Toshihiro Soeno, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/192,052

(22) Filed: Jul. 29, 2005

(30) Foreign Application Priority Data
Sep. 15, 2004 (JP) 2004-267825

(51) Int. Cl. G06F 17/30

(52) U.S. Cl. 707/6

(57) ABSTRACT

A method is disclosed for creating layouts of a rating plate and a label on which approval marks, rating information, or others are to be printed. The method is executed by using a delivery destination specifications storage unit that stores approval information corresponding to each delivery destination and each product-type, and stores descriptive items of the rating plate and the label, a product-specific information storage unit that stores information of each product, and a computer that controls the delivery destination specifications storage unit and the product-specific information storage unit. The computer identifies a product-type based on an input product-type identifier, extracts the approval information and the descriptive items from the delivery destination specifications storage unit, designs a layout of the rating plate and the label based on the extracted approval information and the descriptive items, and selects the material of the rating plate and the label.

### BACKGROUND OF THE INVENTION

1. Field of the Invention

The present invention relates to a method and a system for creating a fixed-format document used to design a rating plate, a tag attached to a product, a label on an external package, or an object for indication, and a method and a program for producing the rating plate, the tag, and the label.

2. Description of the Related Art

In the related art, for example, Utility Model Gazette No. 3004526 discloses a technique of creating a text layout. In this technique, layout data are created including information on positions and sizes of predetermined sections in a fixed format document (a document having a predetermined format), and respective files including the layout data, text data to be inserted into the layout, and graphic data are stored; in addition, a device is used to combine the files of the layout data, the text data and the graphic data; further, calculations are made to match the text data and the graphic data with the sections of the layout data, then parameters in a printing command are assigned with object data to create a printing command, and a printing job is executed in a printing device after executing the printing command.

For example, consider a specification form including a large number of items. When the items or values of the items change, one usually modifies existing data of the items, and determines the text layout of the specification form corresponding to latest contents of the specification. However, if the specification includes a very large number of items, in the above technique, all these items have to be combined, and this is quite cumbersome. In the related art, although the technique of combining text data and graphic data into layout data of a fixed-format document for printing has been proposed, this technique cannot solve this problem.

Further, in Japanese Laid Open Patent Application No. 2003-296307 and Japanese Laid Open Patent Application No. 2003-330375 filed by the present applicant, techniques of fabricating a rating plate are disclosed, in which layout of a rating plate is designed automatically, the type of rating plates having the same contents are designed to be the same, and the time period required for manufacturing the rating plate is shortened.

However, when considering a label or the like, for example, for displaying a safety standard, the same as rating plates, a product designer designs the label independently, hence, even for the same product, different labels may be produced depending on the destination of the product, and local regions of customers. In addition, information depending on the local regions (service center phone numbers, names and phone numbers of sales companies) has to be printed and to be pasted, separately, and this increases the number of steps, and increases cost of raw materials.

Japanese Laid Open Patent Application No. 2002-133194 discloses a technique allowing an orderer to make a design as desired, and the order to be delivered in a short time period. However, this technique does not allow including both information desired by the orderer and other predetermined items.

Japanese Laid Open Patent Application No. 8-269407 and Japanese Laid Open Patent Application No. 8-340182 disclose techniques which improve reusability of a label with the label being formed from a material the same as that of an object on which the label is to be pasted.

As is known, contents of some items of a rating plate and a label need to be examined, and these items cannot be printed in the rating plate or the label without approval of an authority. Usually, this approval takes time. In addition, it also costs time if product-specific information is processed individually by a product designer or a person in charge of the rating plate in a delivery destination region. Thus, it is desirable that the rating plate or the label including many items be fabricated effectively and rapidly even if the time period required for approval fluctuates and the items to be included change.

Further, if the rating plate or the label is fabricated and pasted on a product without considering environmental protection responsiveness, in the recycling processing, the rating plate or the label has to be removed from the object to which the rating plate or the label is pasted. This process lowers working efficiency. Thus, it is desirable to improve working efficiency in the recycling processing.

### SUMMARY OF THE INVENTION

It is a general object of the present invention to solve one or more problems of the related art.

A specific object of the present invention is to provide a method and a system capable of creating a fixed-format document by specifying only text data of the document.

Another specific object of the present invention is to provide a method for producing a rating plate or various labels, which enables the rating plate and the labels including items of approval marks, rating information, and variation information to be produced by the same system, and enables recycling processing without the necessity of removing the rating plate and the labels by using materials corresponding to the material of the object that is the attachment destination of the rating plate and the labels.

According to a first aspect of the present invention, there is provided a fixed-format document creation method, comprising the steps of: preparing text data and graphic data of a fixed-format document, and field data in predetermined positions of which the text data and the graphic data are to be inserted; preparing first combination information representing a combination for identifying the field data from a group of the text data; preparing second combination information representing a combination of the text data group and the graphic data to be inserted into the field data; designating the text data group; extracting the field data matching the text data group designated by the first combination information from a storage unit; and inserting the text data group and the graphic data into the extracted field data according to the second combination information to complete the layout of the fixed-format document.

According to the above invention, because the text data group of, for example, a specifications form, is set to be associated with the text data, such as a template, by designating the text data group, it is possible to identify the field data matching the designated text data group. In addition, because the text data and the graphic data to be inserted into the field data are set to be associated with the field data, when creating a document, it is possible to create a fixed-format document by just designating the text data group.

According to a second aspect of the present invention, there is provided a fixed-format document creation system, comprising: a data base group including text data, graphic data of a fixed-format document and field data to predetermine positions of which the text data and the graphic data are to be inserted, first combination information representing a combination for identifying the field data from a group of the text data, and second combination information representing a combination of the text data group and the graphic data to be inserted into the field data; a terminal device that designates the text data group; and a communication circuit that connects the data base to the terminal device, wherein the terminal device transfers data to and from the data base via the communication circuit to extract the field data matching the text data group designated by the first combination information from the data base, and inserts the text data group and the graphic data into the extracted field data according to the second combination information to complete layout of the fixed-format document.

According to the above invention, it is possible to create a fixed-format document by just designating the text data group. In addition, it is possible to have a configuration in which plural terminals access a data base group, and it is possible to easily create necessary fixed-format documents on the respective terminals. In addition, the terminals can share various types of data in the data base group, and the fixed-format documents on these terminals can be managed as a whole, for example, by a specified terminal or by the data base group.

According to a third aspect of the present invention, there is provided a method of producing a rating plate and a label by using: a delivery destination specifications storage unit that stores information to be printed on the rating plate and the label including approval information corresponding to each delivery destination and each product-type, and stores descriptive items of the rating plate and the label, a product-specific information storage unit that stores information of each product, and a computer that controls the delivery destination specifications storage unit and the product-specific information storage unit, said method comprising the steps of: identifying a product-type based on an input product-type identifier; extracting the approval information and the descriptive items of the rating plate and the label from the delivery destination specifications storage unit based on the input delivery destination of the product and the identified product-type; designing a layout of the rating plate and the label based on the extracted approval information and the descriptive items of the rating plate and the label; and selecting a material to be used for the rating plate and the label.

According to the above invention, because it is possible to obtain not only the descriptive items of the rating plate identified by the product-type identifier, but also the descriptive items of the other labels, and the contents of these descriptive items can be decided, respectively, the rating plate including items of approval marks, rating information, variation information, and various labels can be produced by the same system, and it is not necessary to remove the rating plate and the labels in recycling processing.

According to a fourth aspect of the present invention, there is provided a program executable in a computer for controlling production of a rating plate and a label by using a delivery destination specifications storage unit that stores information to be printed on the rating plate and the label including approval information corresponding to each delivery destination and each product-type, and stores descriptive items of the rating plate and the label, a product-specific information storage unit that stores information of each product, and the computer that controls the delivery destination specifications storage unit and the product-specific information storage unit, said program driving the computer to execute steps of: identifying a product-type based on an input product-type identifier; extracting the approval information and the descriptive items of the rating plate and the label from the delivery destination specifications storage unit based on the input delivery destination of the product and the identified product-type; designing a layout of the rating plate and the label based on the extracted approval information and the descriptive items of the rating plate and the label; and selecting a material to be used for the rating plate and the label.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a diagram schematically showing a configuration of a principal portion of a network system for implementing the fixed-format document creating method of a first embodiment according to the present invention;

FIG. 2 exemplifies creation of various types of data with tools described in the present embodiment;

FIG. 3A through FIG. 3C schematically illustrate examples of the layout template, the first combination data, and the second combination data, respectively, in the first embodiment;

FIG. 4A and FIG. 4B are flowcharts illustrating operations of the first embodiment;

FIG. 5A exemplifies a rating plate A according to the first embodiment;

FIG. 5B illustrates a label attached to an apparatus as an example of the fixed-format document according to the first embodiment;

FIG. 6 is a block diagram illustrating a configuration of a system for manufacturing a rating plate and a label according to a second embodiment of the present invention;

FIG. 7 illustrates data stored in the delivery destination specifications storage unit 22 in the second embodiment;

FIG. 8 illustrates data stored in the machine-type storage unit 23 in the second embodiment;

FIG. 9 illustrates data stored in the product-specific information storage unit 24 in the second embodiment;

FIG. 10 is a flowchart illustrating the operations of the management computer 21 for producing a rating plate and a label according to the second embodiment;

FIG. 11 illustrates an example of a rating plate having a format 40 in the second embodiment;

FIG. 12 illustrates an example of a label having a format 50 in the second embodiment; and

FIG. 13 is a view of a label produced according to the second embodiment.

### DESCRIPTION OF THE PREFERRED EMBODIMENTS

Below, preferred embodiments of the present invention are explained with reference to the accompanying drawings.

### First Embodiment

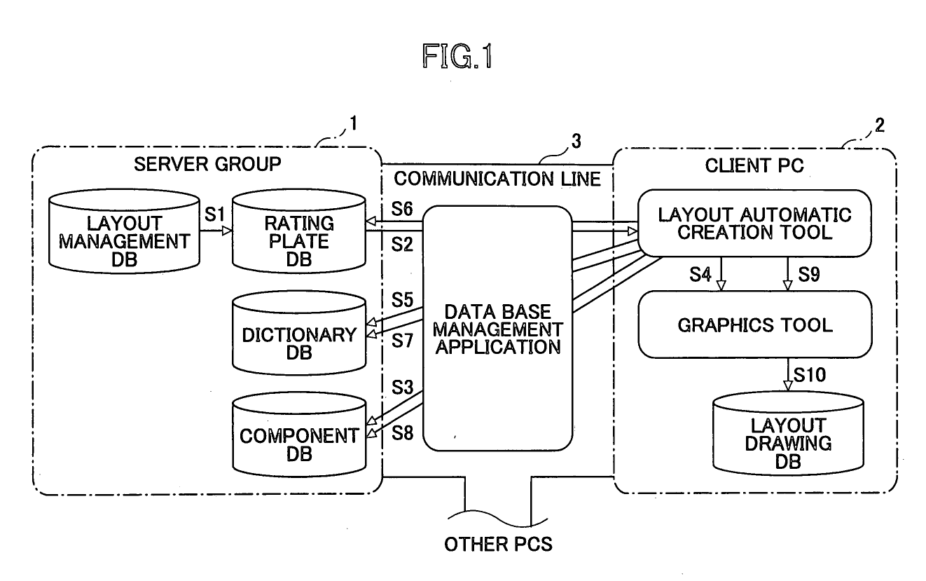

FIG. 1 is a diagram schematically showing a configuration of a principal portion of a network system for implementing the fixed-format document creating method of a first embodiment according to the present invention.

The network system shown in FIG. 1 is constructed by connecting plural companies of a product manufacturer, plural factories, network servers, affiliate companies, or business partner companies with a communication line 3. While being controlled by a data base management application, a server group 1 and a client personal computer (PC) 2 exchange data with each other through the communication line 3 to execute various operations related to business.

The server group 1 corresponds to the “data base group” in the claims. Various types of data bases for implementing the fixed-format document creating method of the first embodiment form a portion of the server group 1.

In the first embodiment, for example, the client PC 2 is installed in a factory to execute the fixed-format document creating method of the present embodiment to create a camera-ready master layout of a rating plate, which is to be attached to a product manufactured in the factory. Based on the completed camera-ready master layout, an order is issued to a printing department or a printing company to print a sheet of the rating plate. For example, this order for printing is issued on the network system through the communication line 3.

Assume that other client PCs are connected to the communication line 3, and able to access the server group 1 in a similar way.

As is well known, the rating plate is a sheet on which production specifications are printed, and products are shipped with the rating plates attached thereto. The contents that ought to be included in the rating plate are determined by the specifications form of the product, but depending on the actual input values of the items of the specifications form (for example, “Brand name”, “selling area”, “product classification”, and so on), the appearance of the printed items on the rating plate changes. For example, as for electronic products, if the selling area is Japan, the rating information may include “rated voltage”, “DC” type or “AC” type, “rated frequency”, “rated current”, “rated power”, “rated power of light source”, “rated power of electric .heating device”, and “total power”. If the selling area is North America, the rating information may include “rated voltage”, “DC” type or “AC” type, “rated frequency”, “rated current”, and “rated power”.

In addition, concerning “approved” mark, “compliance” mark, and “approval number”, “identification number”, and “identification sign”, contents of them also change along with the selling area. For example, if the selling area is Japan, what should be printed on the rating plate may include a double insulation mark, “EMC class”, “(PS)|” mark, and “VCC|(B)” mark. If the selling area is North America, what should be printed on the rating plate includes the double insulation mark, “UL approval” mark, “UL product identification”, “UL file number”, “UL management number”, “North America Laser Declaration Statement” and so on.

In this way, the contents that ought to be printed on the rating plate are quite different, and it is inefficient to separately create a camera-ready master layout for each type of product. In the present embodiment, the camera-ready master layout is created by using the fixed-format document creating method of the present embodiment, and by overall management using various data bases.

The data bases (represented by “DB” in FIG. 1) in the server group 1 for implementing the fixed-format document creating method of the present embodiment include a layout management data base, a rating plate data base, a dictionary data base, and a component data base.

The layout management data base manages work flow from the request of creating a master drawing of the layout, to creation and issuance of the layout, and storage of the master drawing. Here, “master drawing” means an original drawing used for creating plate-making films, printing matrix, or patterned letters during machine graphics fabrication, or in the process of fabricating package-related parts.

The rating plate data base corresponds to the “fixed-format document data base” in the claims. The rating plate data base accommodates specification particulars indicating items and conditions required for creating the layout of the rating plate out of the layouts requested by the layout management data base. In addition, after inputting the specification particulars, based on the input values, the rating plate data base automatically registers the name of a layout template indicating the layout template (corresponding to “field data” in claims) to be used.

A quantity is defined to associate the specification particulars with the layout template names, which are registered in the rating plate data base. This quantity corresponds to the “first combination information” in claims, and is referred to as “first combination data”. The first combination data are stored in the rating plate data base.

The dictionary data base stores information for controlling operations of a layout automatic creation tool.

The dictionary data base stores a quantity referred to as “the second combination data”, which associate items in the specification particulars and items in a layout template defining positions of the items in the specification particulars. The second combination data correspond to the “second combination information” in claims.

Additionally, the dictionary data base stores attributes (text or graphic) of the items in the layout template.

Additionally, the dictionary data base stores information which associates the input values of the items of the specification particulars with documents in the component data base which data base holds graphical files in connection to the input values of the items of the specification particulars.

Additionally, the dictionary data base stores information of conditions of arranging the items of the specification particulars to the items of the layout template.

The component data base stores the layout template (corresponding to “field data” in claims), and files of graphic data and text data, which are used by the layout automatic creation tool. These data are designated by using the names of these components, such as the name of the layout template, the name of the graphic data file, and the name of the text data file.

In addition, the client PC 2 stores applications, such as the layout automatic creation tool, and a graphics tool, in a storage unit, and executes the layout automatic creation tool and the graphics tool.

The layout automatic creation tool is for creating a master drawing of the layout, and has functions of inputting data into a document data base, inputting an OLE file, and controlling operations of the graphics tool.

The graphics tool is a graphic application, and has a function of creating electronic data of the master drawing of the layout. For example, the electronic data are stored in EPS form, and are stored in the data base.

The data base management application provides the electronic mail function, the document data base function, and the function of work flow management. In the network system, the document data base function is used to control operations of the layout automatic creation tool.

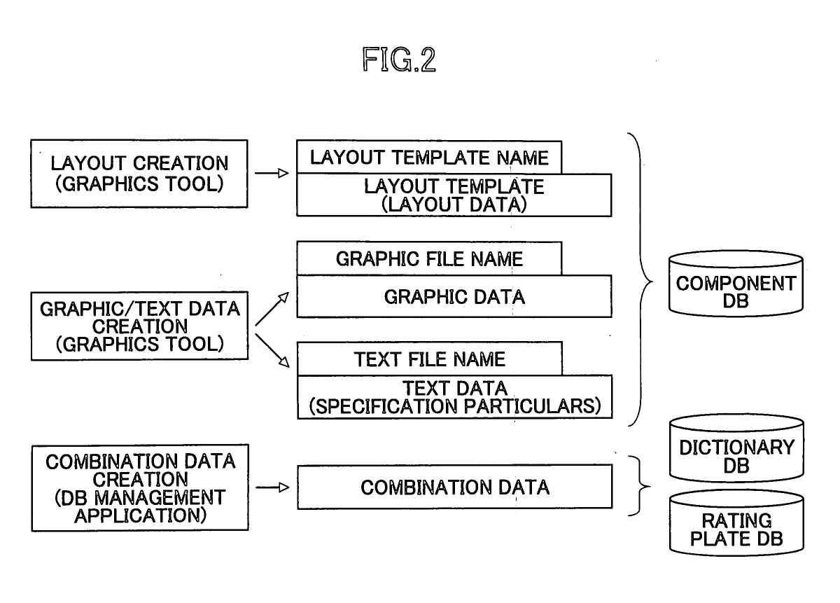

FIG. 2 exemplifies creation of the above types of data with tools described in the present embodiment.

The graphics tool creates various layouts of the rating plate in advance, and registers the layout template data together with layout template names in the component data base in advance. In addition, the graphics tool creates graphic data and text data which determine the graphics and the text, respectively, to be finally printed on the rating plate, and registers the graphic data and text data together with the graphic data file name and the text data file name in the component data base in advance.

The data base management application creates the first combination data and the second combination data, and registers the first combination data in the rating plate data base, and the second combination data in the dictionary data base.

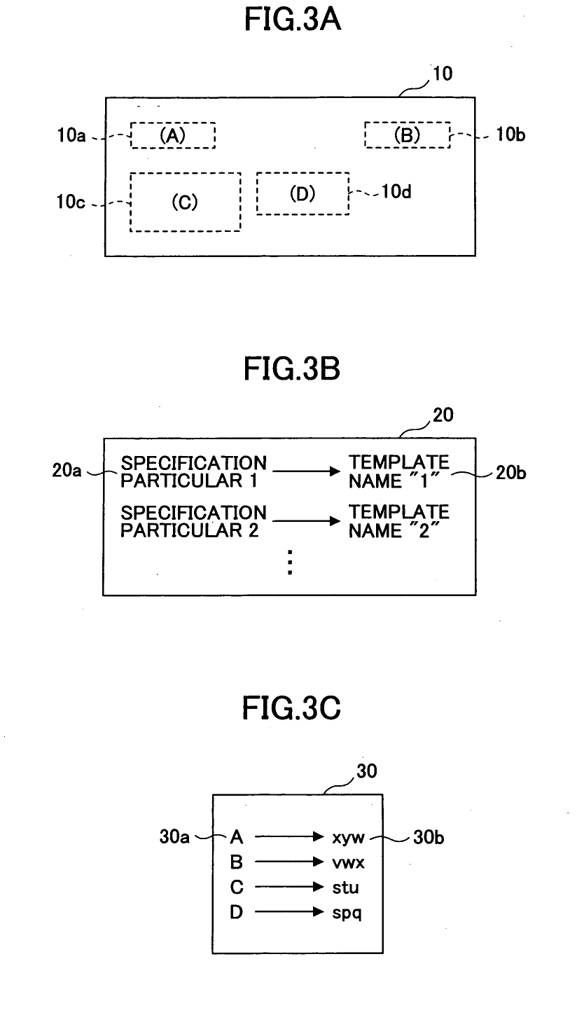

FIG. 3A through FIG. 3C schematically illustrate examples of the layout template, the first combination data, and the second combination data, respectively.

As illustrated in FIG. 3A, the layout template 10 includes items on the rating plate, and values of the items, or zones 10a, 10b, 10c, and 10d where marks are to be printed. Further, the layout template 10 includes position data indicating positions of the zones 10a, 10b, 10c, and 10d, and item data determining items corresponding to the zones 10a, 10b, 10c, and 10d.

As illustrated in FIG. 3B, the first combination data 20 includes specification form data 20a for specifying specification particulars, and data 20b of names of the layout templates corresponding to the specification particulars specified by the data 20a.

As illustrated in FIG. 3C, the second combination data 30 includes data 30a indicating items (A, B, C, D) on the layout template, and field names 30b (xyw, vwx, stu, spq) in connection with the item names (A, B, C, D) and corresponding to items in the specification particulars. It should be noted that the signs (A, B, C, D, and xyw, vwx, stu, spq) used to describe the above items do not have any special meaning.

The field names 30b correspond to the items in the specification particulars, and values are assigned to the field names 30b. The insertion positions of the assigned values on the layout template are associated with the items on the layout template.

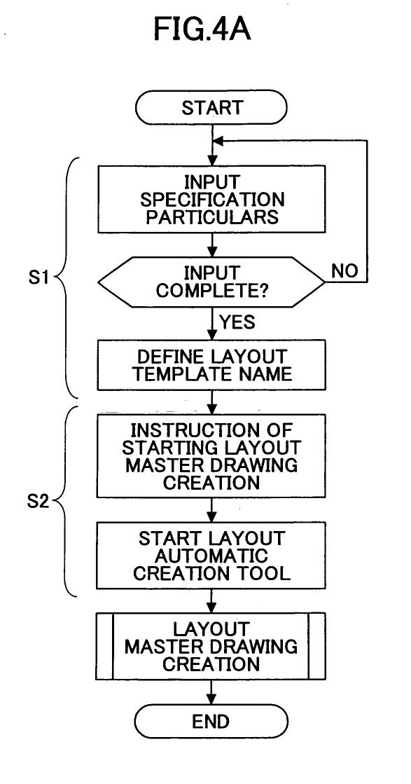

FIG. 4A and FIG. 4B are flowcharts illustrating operations of the present embodiment. Note that the steps in FIG. 4 are also illustrated in FIG. 1 by corresponding arrows.

First, a product designer fills in a form to request layout creation by using the layout management data base, in which layout data for various printing tasks are stored (below, this request is referred to as “layout request”), and also fills in a specification form including the specification particulars when the layout is that of a rating plate. In the present embodiment, the system is configured such that the data base management application is able to perform the layout request in synchronization with filling in the specification form using the layout management data base and the rating plate data base.

As shown in step S1 in FIG. 4A, by using the functions of the rating plate data base, the product designer creates the specification particulars and inputs necessary values therein. When creation of the specification particulars is completed, the corresponding layout template name is recorded in the specification particulars.

In step S2, after selecting a specification particular for layout creation in the rating plate data base, the layout automatic creation tool is started. Due to this, the layout template name is obtained from the rating plate data base, and the layout automatic creation tool operates, then the routine proceeds to the process of layout master drawing creation.

In the process of layout master drawing creation, first, in step S3 shown in FIG. 4B, the graphics tool is started. Based on the layout template name obtained beforehand, the component data base is searched to find the corresponding layout template. Then, the layout automatic creation tool transfers the layout template obtained from the component data base to the graphics tool.

In step S4, the layout automatic creation tool reads in names of all items arranged on the obtained layout template, and confirms that all the item names are defined in the dictionary data base. If an undefined item name is detected, the routine pauses, and the error is reported to the system.

In step S5, a certain item name on the layout template is read in, and a field name of a corresponding specification particular is obtained by using definitions in the dictionary data base. Then, the value input to the obtained field name is read in.

In step S6, a definition in the dictionary data base is obtained from the field name, and the attribute (text or graphic) of the item is determined, and then it is determined whether the insertion processing can be executed.

In case of graphic data, in step S7, the number of the graphic is obtained. Based on the graphic number, the component data base is searched to obtain the corresponding graphic data file.

In step S8, insertion into the layout template is performed. That is, the values of the text data obtained from the field of the specification particular in the rating plate data base, or the file of the graphic data obtained from the component data base are transferred to the graphics tool via the layout automatic creation tool, and are associated with the corresponding items on the layout template to complete the data of the layout master drawing.

Then, in step S9, the completed data of the layout master drawing are stored in a layout drawing data base.

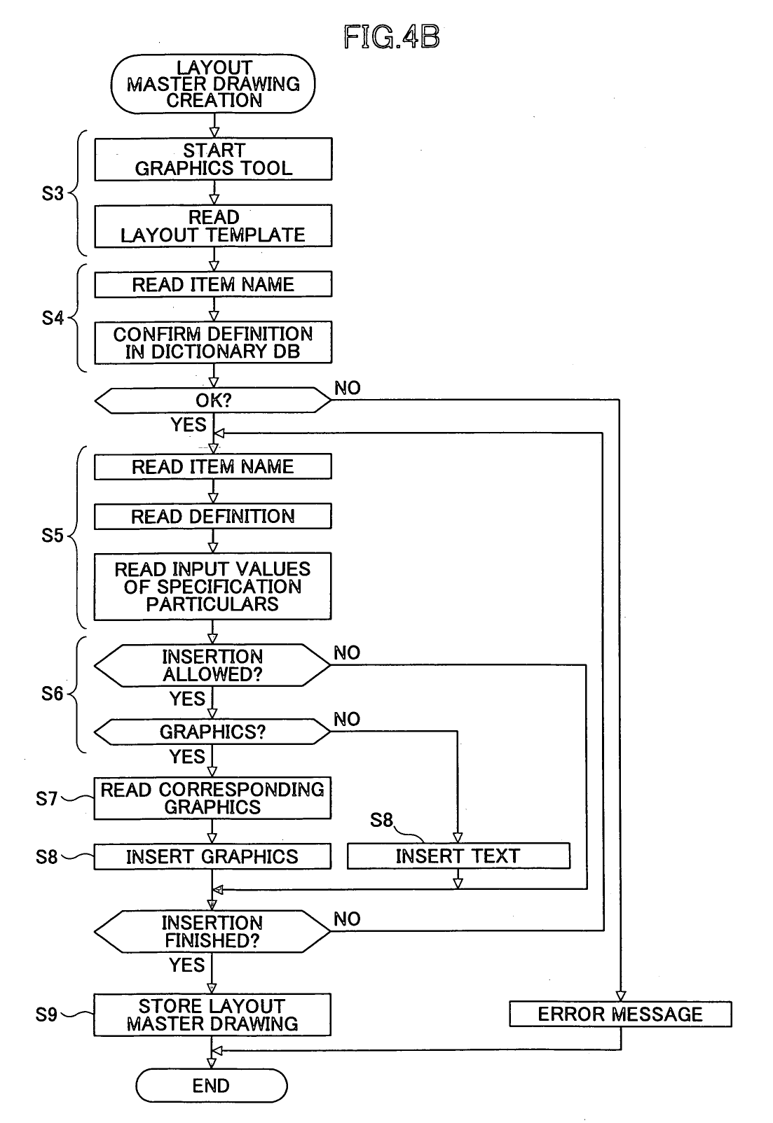

FIG. 5A exemplifies a rating plate A according to the present embodiment. For example, assume that the rating plate A is obtained by printing based on the layout master drawing created in the above way. On the rating plate A, item names (indicated by “a”) “rated voltage”, “rated frequency”, “rated power”, “total power”, “rated current”, “machine type code”, “rated power of light source”, and “rated power of electric heating device” are printed. Below these item names, values (indicated by “b”) of these items are printed, such as “single phase V ˜” (alternating current), “50/60 Hz”, “310 W”, and so on. Further, an approval/compliance mark c is also printed.

Among the above, contents of item names and the positions thereof change along with the type of the layout template, and values b and the approval/compliance mark c change along with the contents of the specification particular.

Then, from the contents input to the specification particular, the layout template is selected with reference to the first combination data, which associate the registered specification particulars with the layout template names. In addition, from the item names input to the specification particular (including graphics), with reference to the second combination data, which associate the items in the specification particulars and items in the layout template, the positions to which the input values b, or the approval/compliance mark c are to be inserted are determined.

In the above embodiment, it is described that the fixed-format document is to be a rating plate; however, the fixed-format document can be others.

FIG. 5B illustrates a label attached to an apparatus as an example of the fixed-format document according to the present embodiment.

The label B shown in FIG. 5B presents information on device maintenance and consulting guidance, for example, a contact address (service center phone number) d, or guidance of service hours e at the contact address, and others. These pieces of information change along with the selling region of the device. Therefore, when creating the layout of the label, the contact address d and the service hours guidance e can be processed based on the specification particular, in the same way as the input values (text or graphics) of the items of the rating plate, and thus obtaining a layout master drawing.

In addition to a rating plate and a label, the fixed-format document can also be a table or a document printed on a packing box, or others.

In the above embodiments, the rating plate data base, the dictionary data base, and the component data base can be installed in different hardware, or in the same hardware.

In addition, the management computer connected to the communication line 3, or the server group 1 itself may manage the data bases in the server group 1. Further, through the communication line 3, the management computer may manage types of the layouts of the rating plate or creation history and so on, which are created by those client PCs.

In the above embodiments, it is assumed that the fixed-format document creation method of the present invention is implemented by a network system, but the fixed-format document creation method of the present invention can be implemented by a single computer.

According to the present embodiment, because the text data group of, for example, a specifications form, is set to be associated with the text data, such as a template, by designating the text data group, it is possible to identify the field data matching the designated text data group. In addition, because the text data and the graphic data to be inserted into the field data are set to be associated with the field data, when creating a document, it is possible to create a fixed-format document by just designating the text data group.

In addition, it is possible to create the layout of a rating plate, even if a large number of items have to be printed on the rating plate, and it is possible to produce the rating plate easily and effectively even when contents of the items to be printed on the rating plate change.

In addition, it is possible to have a configuration in which plural terminals access a data base group, and it is possible to easily create necessary fixed-format documents on the respective terminals. Further, the terminals can share various types of data in the data base group, and the fixed-format documents on these terminals can be managed as a whole, for example, by a specified terminal or by the data base group.

In addition, because different types of data are separated by the component data base, the fixed-format document data base, and the dictionary data base, management of the data is made easy.

### Second Embodiment

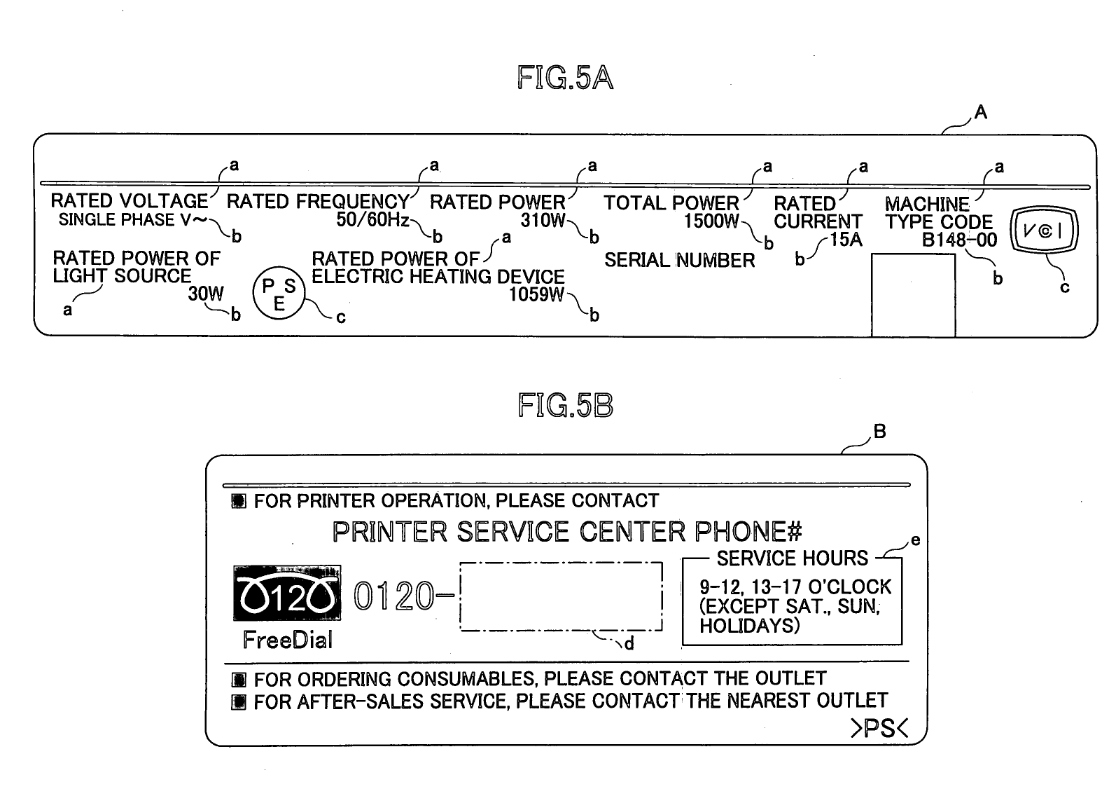

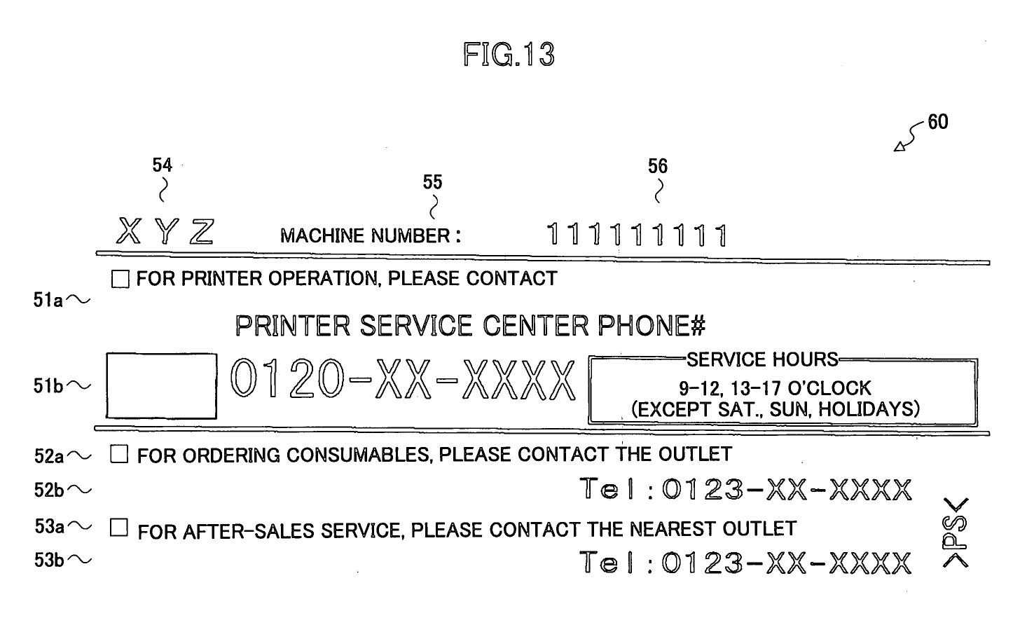

Below, the second embodiment of the present invention is explained with reference to FIG. 6 though FIG. 13. The second embodiment relates to a method of producing a rating plate on which delivery destination information and product-specific descriptive items are printed, or a safety standard sign, or a product-specific tag, a general indicator, and a label on an external package.

FIG. 6 is a block diagram illustrating a configuration of a system for manufacturing a rating plate and a label.

As illustrated in FIG. 6, a manufacturing system 20 is connected to an output terminal 10 through a network N1.

The output terminal 10 has a printing unit to print the rating plate and the label, and then the output terminal 10 outputs the rating plate and the label. The output terminal 10 receives printing data transmitted from a management computer 21 of the manufacturing system 20, and executes printing. For this purpose, the output terminal 10 includes a not-illustrated control unit (for example, CPU), a storage unit (for example, RAM, ROM, a hard-disk, or others), a communication unit, a display (for example, a monitor), and an input unit.

As illustrated in FIG. 6, the manufacturing system 20 includes a management computer 21. The management computer 21 includes a not-illustrated control unit (for example, CPU), a storage unit (for example, RAM, ROM, a hard-disk, or others), and a communication unit. The management computer 21 executes a program executing the method of producing a rating plate and a label to control manufacturing of the rating plate and the label. The program includes various programs, and by executing these programs, the management computer 21 transmits or receives and processes data as described below. In other words, the management computer 21 is driven by the program to identify a product-type, extract approval information and descriptive items of the rating plate and the label, design a layout of the rating plate and the label, and select a material to be used for the rating plate and the label.

The management computer 21 is connected to a delivery destination specifications storage unit 22, a machine-type storage unit 23, and a product-specific information storage unit 24.

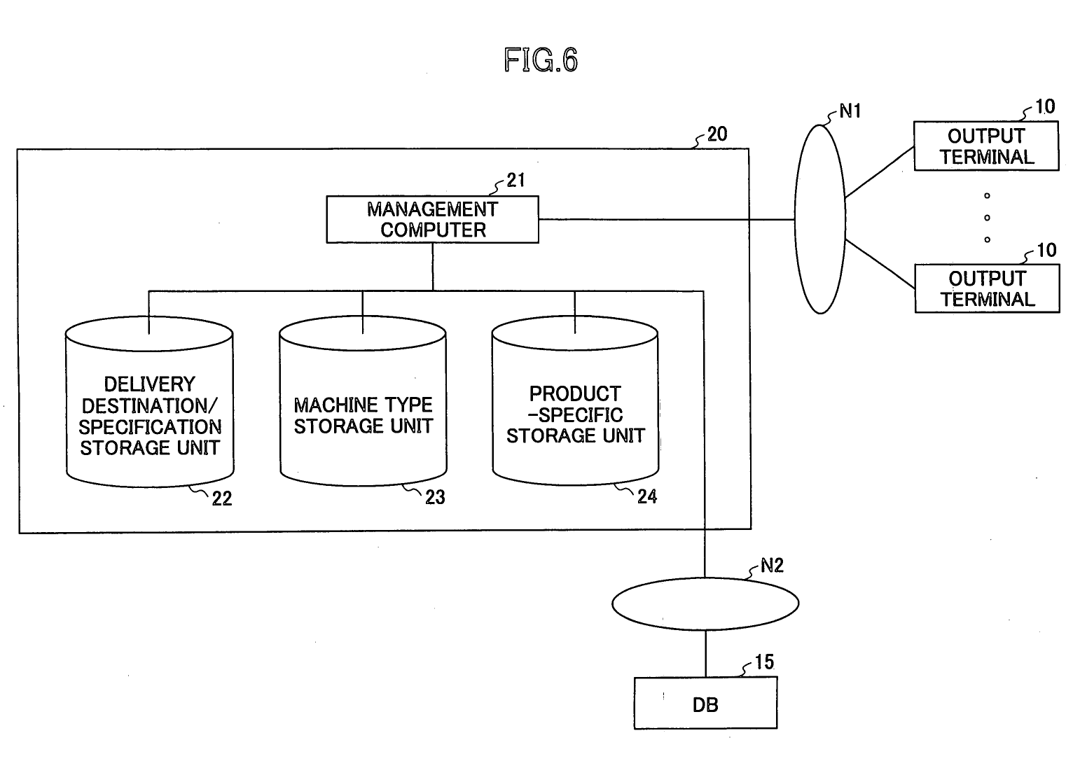

FIG. 7 illustrates an example of data stored in the delivery destination specifications storage unit 22.

As illustrated in FIG. 7, the delivery destination specifications storage unit 22 stores delivery destination data 220 of each product-type. In the present embodiment, the delivery destination data 220 includes data of a delivery destination identifier a1, a product type a2, an approval type a3, descriptive items a4, a rating plate format a5, and a label format a6.

The delivery destination identifier al is for identifying a delivery destination.

The product type a2 represents the type of product, such as a computer, facsimile equipment, and others.

The approval type a3 is determined in advance by the delivery destination identifier a1 and the product type a2. In the present embodiment, if the delivery destination is Japan, the candidates of the approval type a3 may include “PSE”, and “JATE”. Depending on the product type a2, sometimes, both “PSE” and “JATE” are required, and sometimes, either “PSE” or “JATE” is required. If the delivery destination is North America, the approval type a3 is “FCC” (Federal Communications Commission), and if the delivery destination is Europe, the approval type a3 is “Laser”. The descriptive items a4 correspond to rating information to be printed on a rating plate.

The data of the rating plate format a5 correspond to formats of the items to be printed on the rating plate.

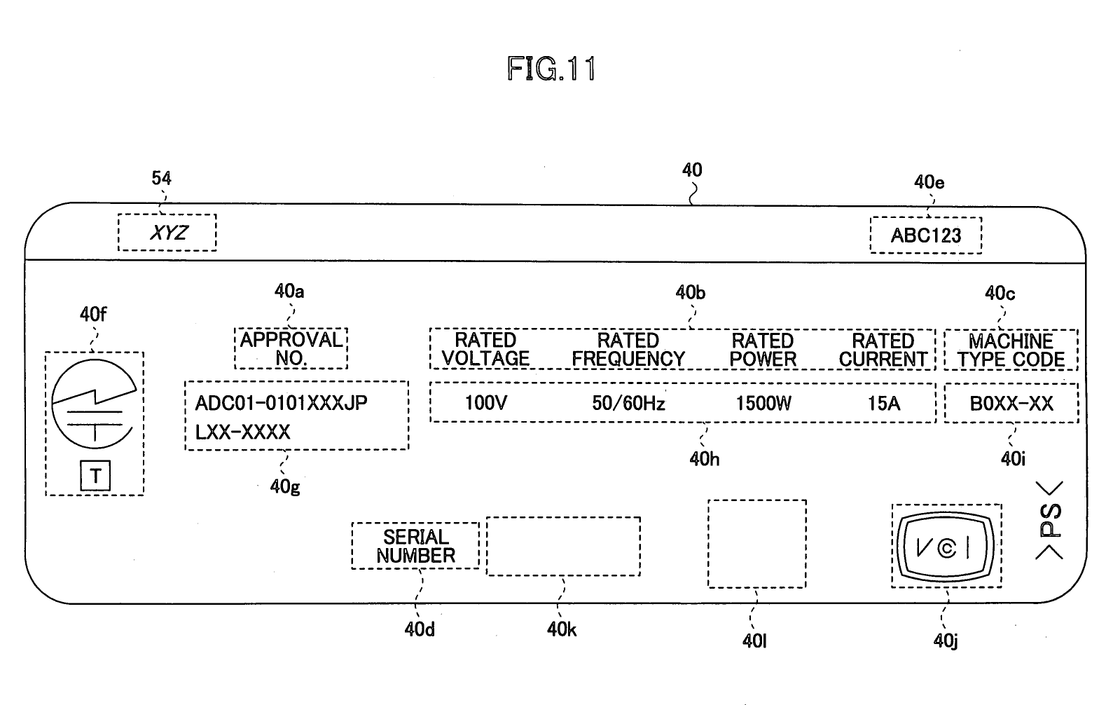

FIG. 11 illustrates an example of a rating plate having a format 40. As illustrated in FIG. 11, the rating plate format 40 includes an approval number title 40a, a rating information title 40b, a machine type code title 40c, and a serial number title 40d. Corresponding to the descriptive items a4, the rating information title 40b includes a rated voltage, a rated frequency, a rated power, and a rated current. Further, the rating plate format 40 includes a machine type name 40e, an approval mark 40f, an authentication number 40g, a rating information indication 40h, a machine code indication 40i, a brand name 54, and position information 40j of other items. Further, the rating plate format 40 includes position information of a manufacturer number 40k, and a two-dimensional bar code indication 40l.

The rating information indication 40h corresponds to the rating information title 40b in connection with the descriptive items a4.

The delivery destination data 220 are stored prior to the process of the present embodiment based on the approval type and other descriptive items that ought to be printed on the rating plate in different countries.

The data of the label format a6 shown in FIG. 7 corresponds to a format of printing items on a label.

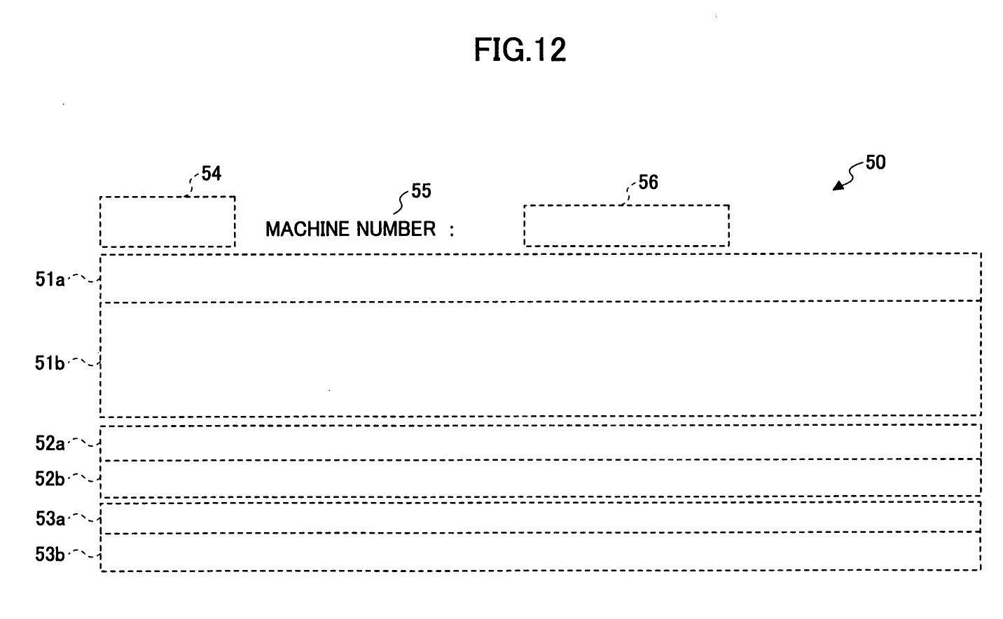

FIG. 12 illustrates an example of a label having a format 50. As illustrated in FIG. 12, the label format 50 includes an operation method contact address title 51a, a consumable contact address title 52a, an after-sales service contact address title 53a, and a machine number title 55. The consumable contact address title 52a and the after-sales service contact address title 53a correspond to the descriptive items a4.

In addition, the label format 50 includes an operation method contact address display section 51b, a consumable contact address display section 52b, and an after-sales service contact address display section 53b.

Further, the label format 50 includes position information of the operation method contact address title 51a, the operation method contact address display 51b, the consumable contact address title 52a, the consumable contact address display 52b, the after-sales service contact address title 53a, the after-sales service contact address display 53b, a brand name 54, the machine number title 55, and a machine number 56. The machine number 56 includes a management number for managing service areas, and a manufacturer's serial number.

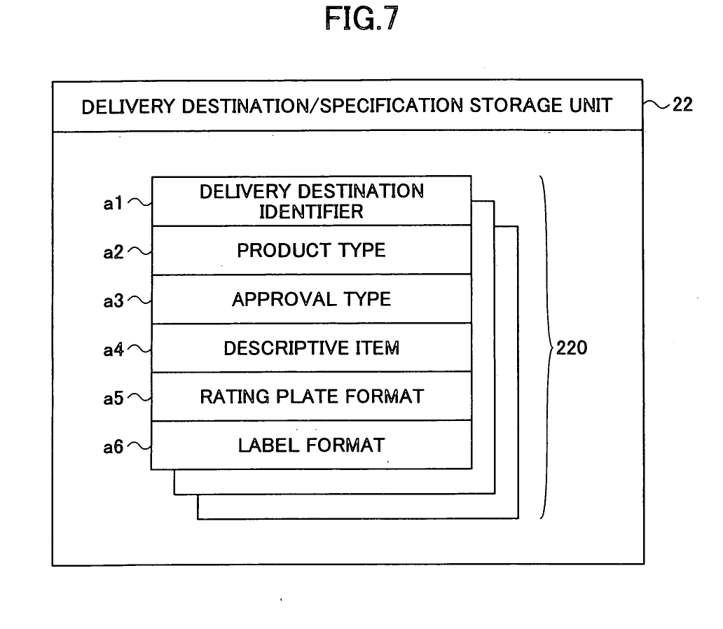

FIG. 8 illustrates an example of data stored in the machine-type storage unit 23.

As illustrated in FIG. 8, the machine-type storage unit 23 stores machine type data 230 corresponding to each machine type identifier. In the present embodiment, the machine type data 230 include data of a machine type identifier b1, a product type a2, approval information b2, rating information b3, and individual information type b4.

The machine type identifier b1 corresponds to an identifier for identifying a machine type.

The product type a2 represents the type of product, the same as the product type a2 in the delivery destination data 220.

The approval information b2 indicates the approval type given to the present machine type.

The rating information b3 indicates ratings of the machine type, and is set to correspond to the items of the descriptive items a4 in the delivery destination data 220.

The individual information type b4 corresponds to the machine type 56 shown in FIG. 12 and information designated when designing the product, such as types of part materials.

The machine type data 230 are stored at the stage of product design, or after approval.

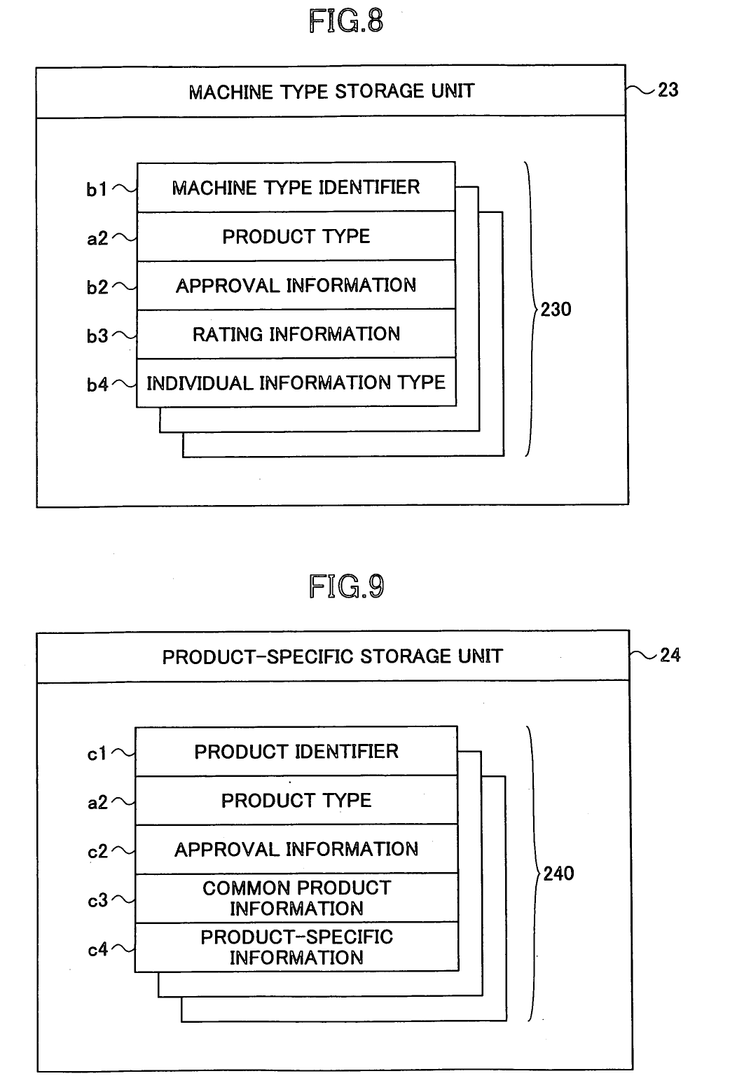

FIG. 9 illustrates an example of data stored in the product-specific information storage unit 24.

As illustrated in FIG. 9, the product-specific information storage unit 24 stores product-specific data 240 for each production identifier. In the present embodiment, product-specific data 240 include data of a machine type identifier c1, a product type a2, approval information c2, product information c3, and product-specific information c4.

The machine type identifier c1 corresponds to an identifier for identifying a machine type.

The product type a2 represents the type of product, the same as the product type a2 in the delivery destination data 220 and the product type a2 in the machine type data 230.

The approval information c2 indicates the approval type a3 given to the present product by each sales company. For example, the approval type a3 corresponds to the approval type determined in advance by using the delivery destination identifier al and the product type a2. In the present embodiment, for example, the approval information c2 may be the presentation of “please connect to ground”, “consumable contact address”, or “after-sales service contact address”.

The product information c3 is the information of the present product, and is set to correspond to the items of the descriptive items a4 in the delivery destination data 220, and the individual information type b4 in the machine type data 230. For example, the product information c3 may be the name and phone number of a distribution outlet, the phone number of a service person, or a consumable contact address.

The product-specific information c4 corresponds to information of the delivery region or the customer of the product, which are special product information. For example, the product-specific information c4 may be the name or phone number of a distribution outlet, the phone number of a service person, an IP address for network connection, or a capital assets number of the customer, and an attachment position desired by the customer.

The product-specific data 240 are stored at the stage of product design, or after approval, or when the product is assembled.

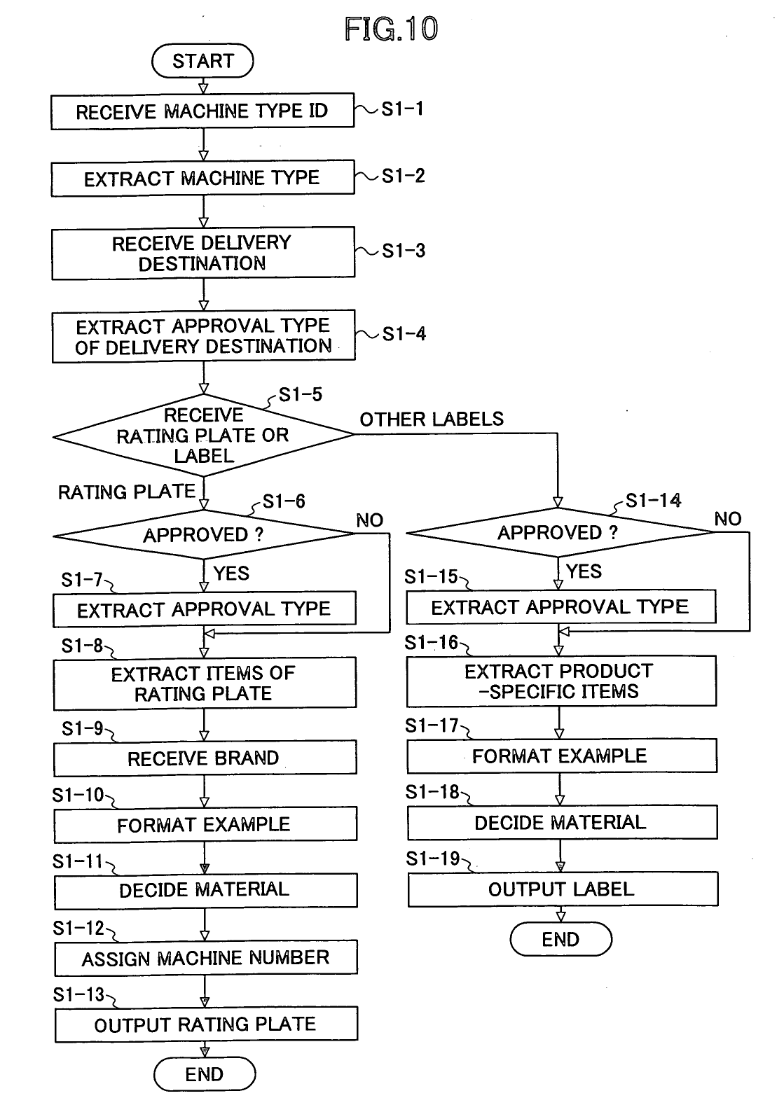

Next, with reference to FIG. 10, descriptions are made of the operations of the management computer 21, which has the above configuration, for producing a rating plate and a label by using the output terminal 10.

FIG. 10 is a flowchart illustrating the operations of the management computer 21 for producing a rating plate and a label according to the second embodiment.

As illustrated in FIG. 10, with the output terminal 10, an operator requests production of a rating plate and a label. In this process, the output terminal 10 transfers production request data to the management computer 21 via the network N1. Receiving the production request data, the management computer 21 sends a request to the output terminal 10 for inputting the machine type identifier b1.

Receiving the request, the output terminal 10 prompts the operator to input the machine type identifier b1. If the operator inputs the machine type identifier b1, the output terminal 10 transfers the machine type identifier b1 to the management computer 21.

In step S1-1, the management computer 21 receives the machine type identifier bl via the network N1.

In step S1-2, the management computer 21 extracts the product type a2 from the machine-type storage unit 23 based on the received machine type identifier b1.

In step S1-3, the management computer 21 sends a request to the output terminal 10 for inputting the delivery destination identifier a1. When the operator inputs the delivery destination identifier a1, the output terminal 10 transfers the delivery destination identifier a1 to the management computer 21. Then, the management computer 21 receives the delivery destination identifier a1 via the network N1.

In step S1-4, the management computer 21 extracts the approval type a3 from the delivery destination specifications storage unit 22 based on the received delivery destination identifier a1.

In step S1-5, after receiving a request of the operator from the output terminal 10 for outputting a rating plate and a label, the management computer 21 determines which of a rating plate and a label the request is made to output.

If the management computer 21 determines that the operator is requesting output of a rating plate, in step S1-6, the management computer 21 determines whether an approval of the approval type a3 is present.

If it is determined that an approval of the approval type a3 has been set in the approval information b2, in step S1-7, the management computer 21 extracts an approval identifier. Here, the approval identifier is an approval number given when the approval is made. In the present embodiment, the approval identifier is stored in a not-illustrated storage unit, while being set in connection with the machine type identifier b1 and the approval type a3.

In step S1-8, based on the descriptive items a4 in the delivery destination data 220, the management computer 21 extracts information of the item corresponding to the rating information b3 in the machine type data 230.

In step S1-9, the management computer 21 sends a request to the output terminal 10 for inputting the brand name to be printed on the rating plate. When the operator inputs the brand name, the output terminal 10 transfers the brand name to the management computer 21. Then, the management computer 21 receives the brand name via the network N1.

In step S1-10, based on the delivery destination data 220, the machine type data 230, and input information, the management computer 21 displays an example of the rating plate format.

In step S1-11, if the operator accepts the rating plate format, the operator sends an output request to the management computer 21, and then the management computer 21 sets (selects) the material of the rating plate.

In step S1-12, the management computer 21 assigns machine numbers in response to the requested number of sheets.

In step S1-13, the management computer 21 outputs the rating plate format to the output terminal 10.

The output terminal 10 selects the material of the rating plate based on the received material data, and prints the rating plate based on the rating plate printing data.

If the management computer 21 determines that the operator is requesting output of a label in step S1-5, then in step S1-14, the management computer 21 determines whether an approval of the approval type a3 is present.

Specifically, based on the machine type identifier c1, the management computer 21 extracts the approval information c2 from the product-specific data 240, and determines whether an approval of the approval type a3 is made.

If it is determined that the approval of the approval type a3 has been set in the approval information c2, the management computer 21 determines that the approval of the approval type a3 has been made.

Then, in step S1-15, the management computer 21 extracts an approval identifier. Here, the approval identifier corresponds to the approval type which is assigned by each sales company and in each delivery region. In the present embodiment, the approval identifier is stored in a not-illustrated storage unit, while being set in connection with the machine type identifier c1 and the approval type a3.

In step S1-16, based on the descriptive items a4 in the delivery destination data 220, the management computer 21 extracts information of the item corresponding to the product information c3 in the product-specific data 240.

Then, the management computer 21 sends a request to the output terminal 10 for inputting the product information to be printed on the label. When the operator inputs the product information, the output terminal 10 transfers the product information to the management computer 21. Then, the management computer 21 receives the product information via the network N1.

In step S1-17, based on the delivery destination data 220, the machine type data 230, and input information, the management computer 21 displays an example of the label format.

Specifically, the management computer 21 generates a label format corresponding to the product type a2 in the label format a6 in the delivery destination data 220. Then, the management computer 21 outputs label displaying data to the output terminal 10 to display the label format. Receiving the label format data, the output terminal 10 displays the label format on its monitor.

For example, the label format 50 shown in FIG. 12 is displayed. At this state, the label format 50 includes an operation method contact address section 51, a consumable contact address section 52, and an after-sales service contact address section 53. As described above, what is printed on the label in FIG. 12 also includes the brand name 54, the machine number title 55, and the machine number 56, where the machine number displayed in section 56 includes the management number for managing service areas and a manufacturer's serial number.

The operation method contact address section 51 displays the operation method contact address extracted from a not-illustrated storage unit based on the machine type identifier cl in the product-specific data 240.

The consumable contact address section 52 and the after-sales service contact address section 53 present the consumable contact address and the after-sales service contact address, which are extracted from the not-illustrated storage unit based on the approval information c2 in the product-specific data 240.

The operator confirms the label format displayed on the monitor of the output terminal 10, and when the operator desires to produce the label by using the label format 50 displayed on the monitor, the operator sends a request for outputting the label to the management computer 21.

Receiving this request, the management computer 21 sends a request to the output terminal 10 for inputting the required number of labels.

Receiving this request, the operator inputs the number of labels and this number is displayed on the monitor.

When the operator inputs the number of labels, the output terminal 10 transfers the number of labels to the management computer 21. Then, the management computer 21,receives the number of labels via the network N1.

In step S1-18, the management computer 21 sets the material of the label, and assigns the product-specific information c4.

After that, in step S1-19, the management computer 21 outputs the label printing data to the output terminal 10 for producing the labels. The label printing data correspond to the label format displayed on the monitor, to which the product-specific information c4 is assigned.

Then, the output terminal 10 selects the material of the labels based on the received material data, and prints the labels based on the product-specific printing data.

As a result, for example, a label 60 as shown in FIG. 13 is printed.

FIG. 13 is a view of a label produced by the method according to the present embodiment.

As shown in FIG. 13, in the label 60, all items in the label format 50 are assigned with actual values.

Summarizing the present embodiment, the present embodiment discloses a method of producing a rating plate and a label by using a delivery destination specification storage unit 22 that stores information to be printed on the rating plate and the label including approval type a3 corresponding to each delivery destination and each product-type, and stores descriptive items of the rating plate and the label, a product-specific information storage unit 24 that stores information of each product, and a management computer 21 that controls the delivery destination specifications storage unit 22 and the product-specific information storage unit 24.

According to the method of the present embodiment, the management computer 21 identifies a product-type of the product based on an input product-type identifier, extracts the approval type a3 and the descriptive items of the rating plate and the label from the delivery destination specifications storage unit 22 based on the input delivery destination of the product and the identified product-type, and designs a layout of the rating plate and the label based on the extracted approval type a3 and the descriptive items of the rating plate and the label.

In addition, the present embodiment discloses a program that drives the management computer 21 to control the manufacturing process of a rating plate and a label by using a delivery destination specification storage unit 22 that stores information to be printed on the rating plate and the label including approval type a3 corresponding to each delivery destination and each product-type, and stores descriptive items of the rating plate and the label, a product-specific information storage unit 24 that stores information of each product, and the management computer 21 that controls the delivery destination specifications storage unit 22 and the product-specific information storage unit 24.

When the program is executed on the management computer 21, the management computer 21 is driven to identify a product-type of the product based on an input product-type identifier, extract the approval type a3 and the descriptive items of the rating plate and the label from the delivery destination specifications storage unit 22 based on the input delivery destination of the product and the identified product-type, and design a layout of the rating plate and the label based on the extracted approval type a3 and the descriptive items of the rating plate and the label.

As a result, not only the descriptive items of the rating plate but also the descriptive items of the label are specified by the machine-type identifier, and thus the contents to be inserted on the rating plate and the label can be decided.

In addition, when designing the layout, the approval type a3, contents of the descriptive items of the rating plate and the label, and the product-specific information are input, and the layout is designed based on the approval type a3, the contents of the descriptive items of the rating plate and the label, and the product-specific information. Because the contents to be printed are determined based on the approval information, it is possible to effectively design the layout of the rating plate and the label.

In addition, the management computer 21 is connected to a machine-type data storage unit 23 that stores machine-type information including the approval information and the descriptive items of the rating plate and the label corresponding to each machine-type identifier. When designing the layout of the rating plate and the label, the management computer 21 extracts the machine-type information related to the extracted approval information a3 and the descriptive items of the rating plate and the label from the machine-type data storage unit 23 and the product-specific information from the product-specific information storage unit 24, and designs the layout of the rating plate and the label based on the extracted machine-type information and the product-specific information. Therefore, as long as an approval is granted before making a request for fabricating the rating plate and the label, this approval information can be assigned; hence, it is possible to print the contents of the approval when production of the product is completed.

In addition, when selecting the material of the rating plate and the label, the management computer 21 selects the material of the rating plate and the label corresponding to the material information of the object to which the rating plate and the label are to be attached, specifically, the material of the rating plate and the label is the same as the material of the object to which the rating plate and the label are to be attached. Therefore, the object with the rating plate and the label thereon can be processed directly in recycling processing without removing the rating plate and the label. The object to which the rating plate and the label are to be attached may be a cover or a case made from polystylene (PS), polyester(PET), or acrylonitrile—butadiene—styrene (ABS), and materials other than resins, such as a zinc-copper plate, or other metal materials. The rating plate and the label are also made from these materials, and the material name can be printed on the rating plate and the label.

Because the management computer 21 is used to control data input and the descriptive items of the rating plate and the label, the control program automatically determines the contents to be printed upon input from the output terminal 10. Therefore, the operator does not fail to input the approval type a3 and the descriptive items.

In addition, because information of one rating plate is extracted independently from other labels, and the layouts of the rating plate and the labels are specified independently based on their information, the rating plate and other various labels can be produced by the same system, and it is possible to effectively print the rating plate and the labels.

Because the product-specific information storage unit 24 defines contents of the descriptive items of the rating plate and the label for each product, at least a single rating plate or a label can be printed. Therefore, it is possible to assign certain information to each product, for example, it is possible to provide customization for one customer.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

For example, in the present embodiment, until a request is made for fabricating the rating plate or the label, the machine type data 230 and the product-specific data 240 are used, which are input by the operator in advance. Instead, when making the request for fabricating the rating plate or the label, the operator can be prompted to input the approval information, the rating information, and the product information one by one. For example, the management computer 21 displays an input window on the monitor of the output terminal 10 for inputting the approval information, the rating information, and the product information, and the operator can input these pieces of information from this input window.

In addition, in the present embodiment, the operator attaches the fabricated rating plate or the label to the product, which is manufactured on a different production line. Instead, attachment of rating plate or the label to the product may be automated. In doing so, attachment of rating plate or the label to the product can be performed more efficiently.

In addition, in the present embodiment, the label format or the rating plate format is determined based on the rating plate format a5 or the label format a6 in the delivery destination data 220, and regardless of the presence of an approval, the label or the rating plate is produced to have the same format. Instead, the format can be changed depending on presence of an approval. For example, when the approval of the approval type a3 is not present, the size of the letters, graphics, or intervals can be adjusted for printing.

In addition, in the present embodiment, the storage units 22, 23, and 24 are established in the manufacturing system 20. But the storage units 22, 23, and 24 may be installed in different systems, furthermore, the-storage units 22, 23, and 24 may be installed in exclusively-used systems.

According to the present embodiment, because it is possible to obtain not only the descriptive items of the rating plate identified by the product-type identifier, but also the descriptive items of the other labels, and the contents of these descriptive items can be decided, respectively, the rating plate including items of approval marks, rating information, variation information, and various labels can be produced by the same system, and it is not necessary to remove the rating plate and the labels in recycling processing.

In addition, because the contents to be printed are determined based on the approval information, it is possible to effectively design the layout of the rating plate and the label.

Further, as long as an approval is granted before a request for fabricating the rating plate and the label is made, information related to this approval can be obtained; hence, it is possible to print the contents of the approval when manufacture of the product is completed.

Because the material of the rating plate and the label is selected corresponding to the material of the attachment destination member, the member with the rating plate and the label thereon can be processed directly in recycling processing without removing the rating plate and the label.

Because the rating plate and various labels can be produced by the same system, it is possible to effectively print the labels.

In addition, printing can be performed on at least one sheet; hence, it is possible to assign information to each product, for example, it is possible to perform customization for one customer.

This patent application is based on Japanese Priority Patent Application No. 2004-023352 filed on Jan. 30, 2004, and Japanese Priority Patent Application No. 2004-267825 filed on Sep. 15, 2004, the entire contents of which are hereby incorporated by reference.

What is claimed is:

1. A fixed-format document creation method, comprising the steps of:
preparing text data and graphic data of a fixed-format document, and field data in predetermined positions of which the text data and the graphic data are to be inserted;
preparing first combination information representing a combination for identifying the field data from a group of the text data;
preparing second combination information representing a combination of the text data group and the graphic data to be inserted into the field data;
designating the text data group;
extracting the field data matching the text data group designated by the first combination information from a storage unit; and
inserting the text data group and the graphic data into the extracted field data according to the second combination information to complete a layout of the fixed-format document.

2. The fixed-format document creation method as claimed in claim 1, wherein
the text data and the graphic data are to be used in a rating plate;
the field data include a template defining positions of text data and graphic data in the rating plate; and
the text data group includes items of specifications defining contents of the rating plate.

3. A fixed-format document creation system, comprising:
a data base group including text data, graphic data of a fixed-format document and field data into predetermined positions of which the text data and the graphic data are to be inserted, first combination information representing a combination for identifying the field data from a group of the text data, second combination information representing a combination of the text data group and the graphic data to be inserted into the field data;
a terminal device that designates the text data group; and
a communication circuit that connects the data base to the terminal device;
wherein
the terminal device transfers data to and from the data base via the communication circuit to extract the field data matching the text data group designated by the first combination information from the data base, and insert the text data group and the graphic data into the extracted field data according to the second combination information to complete a layout of the fixed-format document.

4. The fixed-format document creation system as claimed in claim 3, wherein
the data base group comprises:
a component data base including the text data, the graphic data, and the field data;
a fixed-format document data base including the first combination information; and
a dictionary data base including the second combination information.

5. The fixed-format document creation system as claimed in claim 3, wherein
the text data and the graphic data are to be used in a rating plate;
the field data include a template defining positions of the text data and the graphic data in the rating plate; and
the text data group includes items of specifications defining contents of the rating plate.

6. A method of producing a rating plate and a label by using
a delivery destination specifications storage unit that stores information to be printed on the rating plate and the label including approval information corresponding to each delivery destination and each product-type, and stores descriptive items of the rating plate and the label,
a product-specific information storage unit that stores information of each product, and
a computer that controls the delivery destination specifications storage unit and the product-specific information storage unit,
said method comprising the steps of:
identifying a product-type based on an input product-type identifier;
extracting the approval information and the descriptive items of the rating plate and the label from the delivery destination specifications storage unit based on the input delivery destination of the product and the identified product-type;
designing a layout of the rating plate and the label based on the extracted approval information and the descriptive items of the rating plate and the label; and
selecting a material to be used for the rating plate and the label.

7. The method as claimed-in claim 6, wherein
the step of designing the layout of the rating plate and the label includes the steps of:
inputting a value of the approval information, contents of the descriptive items of the rating plate and the label, and a value of the product-specific information; and
designing the layout of the rating plate and the label based on the value of the approval information, the contents of the descriptive items of the rating plate and the label, and the value of the product-specific information.

8. The method as claimed in claim 6, wherein
the computer is connected to a machine-type storage unit that stores machine-type information including the approval information and the descriptive items of the rating plate and the label corresponding to each machine-type identifier; and
the step of designing the layout of the rating plate and the label includes the steps of:
extracting the machine-type information related to the extracted approval information and the descriptive items of the rating plate and the label from the machine-type storage unit, and the product-specific information from the product-specific information storage unit; and
designing the layout of the rating plate and the label based on the extracted machine-type information and the product-specific information.

9. The method as claimed in claim 6, wherein
the step of selecting the material of the rating plate and the label includes the steps of:
extracting attachment destination information of the rating plate and the label based on the product-type information and the product-specific information; and
selecting the material of the rating plate and the label corresponding to the extracted attachment destination information.

10. The method as claimed in claim 6, wherein
information of one rating plate or one label is extracted independently from other rating plates or labels, and the material of the one rating plate or the one label is selected independently from the other rating plates or labels.

11. The method as claimed in claim 6, wherein
the product-specific information storage unit defines contents of the descriptive items of the rating plate and the label for each product.

12. A program executable in a computer for controlling production of a rating plate and a label by using a delivery destination specifications storage unit that stores information to be printed on the rating plate and the label including approval information corresponding to each delivery destination and each product-type, and stores descriptive items of the rating plate and the label,
a product-specific information storage unit that stores information of each product, and
the computer that controls the delivery destination specifications storage unit and the product-specific information storage unit,
said program driving the computer to execute the steps of:
identifying a product-type based on an input product-type identifier;
extracting the approval information and the descriptive items of the rating plate and the label from the delivery destination specifications storage unit based on the input delivery destination of the product and the identified product-type;
designing a layout of the rating plate and the label based on the extracted approval information and the descriptive items of the rating plate and the label; and
selecting a material to be used for the rating plate and the label.

13. The program as claimed in claim 12, wherein
the step of designing the layout of the rating plate and the label includes the steps of:
inputting a value of the approval information, contents of the descriptive items of the rating plate and the label, and a value of the product-specific information; and
designing the layout of the rating plate and the label based on the value of the approval information, the contents of the descriptive items of the rating plate and the label, and the value of the product-specific information.

14. The program as claimed in claim 12, wherein
the step of designing the layout of the rating plate and the label includes the steps of:
extracting machine-type information related to the extracted approval information and the descriptive items of the rating plate and the label from a machine-type storage unit, and the product-specific information from the product-specific information storage unit, said machine-type storage unit being connected to the computer and storing the machine-type information including the approval information and the descriptive items of the rating plate and the label corresponding to each machine-type identifier; and
designing the layout of the rating plate and the label based on the extracted machine-type information and the product-specific information.

15. The program as claimed in claim 12, wherein
the step of selecting the material of the rating plate and the label includes the steps of:
extracting attachment destination information of the rating plate and the label based on the product-type information and the product-specific information; and
selecting the material of the rating plate and the label corresponding to the extracted attachment destination information.
